(19) United States
(12) Patent Application Publication
(10) Pub. No.: US 2006/0065283 A1
(43) Pub. Date: Mar. 30, 2006

(54) Collapsible toothpick

(76) Inventor: Farzad Shaygan, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/954,757

(22) Filed: Sep. 30, 2004

(51) Int. Cl. A61C 15/00

(52) U.S. Cl. 132/329

(57) ABSTRACT

According to one embodiment of the present invention, a toothpick is provided, which comprises a longitudinally compressible tip comprising a spirally wound ribbon. In some embodiments, the toothpick may further comprise an elongate body configured adjacent a proximal end of the tip. The spirally wound ribbon of the toothpick may comprise nylon or other suitable materials.

### BACKGROUND OF THE INVENTION

1. Field of the Invention

Preferred aspects of the present invention relate to a collapsible toothpick. Preferred embodiments of the present invention are particularly useful for cleaning interdental cavities while preventing damage to the soft tissue of the user's gums.

2. Description of the Related Art

Toothpicks are commonly used to remove food particles and other foreign matter from between a user's teeth and gums. They are typically inserted between a user's teeth and then twisted and wiggled back and forth in order to dislodge such foreign matter.

Unfortunately, most toothpicks are made of relatively rigid plastic materials, and insertion between a user's teeth is often fairly difficult. As a result, users often find themselves attempting to force conventional toothpicks between their teeth, and often cause damage to the soft tissue of their gums when the toothpicks break through an obstruction.

It is an object of this invention, therefore, to provide a toothpick that can remove foreign matter from between a user's teeth, but prevent damage to the soft tissue of the user's gums.

### SUMMARY OF THE INVENTION

According to one embodiment of the present invention, a toothpick is provided, which comprises a longitudinally compressible tip comprising a spirally wound ribbon. In some embodiments, the toothpick may further comprise an elongate body configured adjacent a proximal end of the tip. The spirally wound ribbon of the toothpick may comprise nylon or other suitable materials.

According to another embodiment of the present invention, a toothpick may comprise an elongate body, and a compressible tip configured at one end of the elongate body, said compressible tip comprising a tapered, overlapping spiral of nylon ribbon, wherein the distal end of said compressible tip is configured for insertion between a user's teeth.

### BRIEF DESCRIPTION OF THE DRAWINGS

The preferred embodiments of this invention, illustrating all its features, will now be discussed in detail. These embodiments depict the novel and nonobvious method and toothpick of this invention shown in the accompanying drawings, which are for illustrative purposes only. The drawings include the following Figures, with like numerals indicating like parts.

FIG. 1 shows a perspective view of one embodiment of a toothpick in keeping with the present invention.

FIG. 2A shows an enlarged, perspective view of the toothpick of FIG. 1 in an extended configuration.

FIG. 2B shows an enlarged, perspective view of the toothpick of FIG. 1 in a compressed configuration.

### DETAILED DESCRIPTION OF THE PREFERRED EMBODIMENT

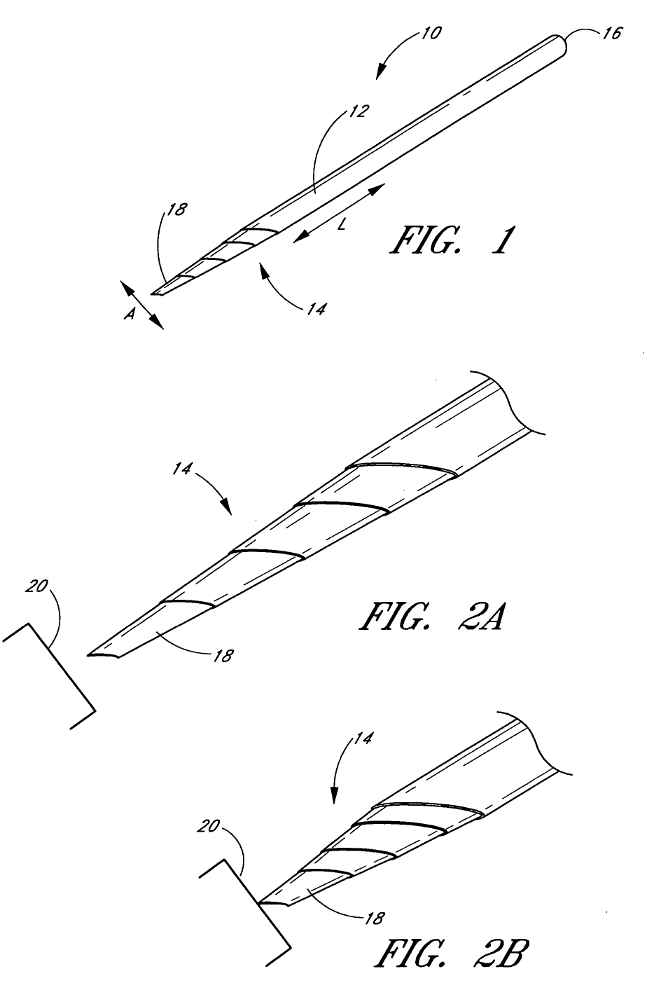

FIG. 1 illustrates one embodiment of a toothpick that solves the above problems by being compressible in a longitudinal direction while being relatively stiff along other axes. The toothpick 10 may be used to clean food particles and other foreign matter from between a user's teeth, gums and periodontal pockets, but will preferably prevent a user from doing damage to his or her gums.

In the illustrated embodiment, the toothpick 10 comprises an elongate body 12 and a compressible tip 14. In other embodiments, the toothpick 10 may not include an elongate body 12 and may simply comprise a longer compressible tip 14. The elongate body 12 of the preferred embodiment is preferably formed from synthetic resin materials in a manner well known to those of skill in the art. The elongate body 12 may be formed of the same or different materials as the compressible tip 14 and may be manufactured integrally or separately. In one embodiment, the elongate body 12 may narrow towards its proximal end 16, thereby providing another surface that can penetrate between a user's teeth.

The overall length of the toothpick 10 is preferably between about one and six inches, and more preferably between about two and three inches. As is well known to those of skill in the art, the toothpick 10 may be formed from many different materials and may have any desired size.

The compressible tip 14 is preferably formed of a single strip of material configured in an overlapping spiral that tapers towards its distal end 18. This distal end 18 defines the surface that may be inserted between a user's teeth and gums to remove food particles therefrom, and therefore has a relative small cross-section. In one embodiment, the material forming the compressible tip 14 is nylon ribbon. However, other materials may also be used, including carbon fiber, resins, composites, polymers, and other materials well known to those of skill in the art. Of course, in other embodiments, the compressible tip 14 may be made of other materials that offer differential resistance to forces along different axes, as is well known to those of skill in the art.

The typical movement of the toothpick 10 may be defined by two principal axes. As illustrated in FIG. 1, the toothpick 10 may be pushed between the teeth by moving it along the longitudinal axis L, and may be moved up and down between the teeth along the lateral axis A.

Since the compressible tip 14 may be formed of a single, overlapping strip of material, it is relatively rigid along the lateral axis A. As the toothpick 14 is moved up and down along this axis, the compressible tip 14 does not deflect very much and acts similarly to a conventional toothpick.

However, when the toothpick 10 is moved in a longitudinal direction, as when it is pushed towards a user's gum, the compressible tip 14 may be compressed, such that much of the force towards the gum may be dissipated. This action of the toothpick 10 is illustrated in FIGS. 2A and 2B. In FIG. 2A, the toothpick 10 is illustrated in an extended configuration approaching a surface 20 along its longitudinal axis L. The compressible tip 14 is fully extended in a relaxed spiral.

In FIG. 2B, the toothpick 10 is illustrated in a compressed configuration abutting the surface 20. As the toothpick 10 was pushed into this configuration, the distal end 18 of the compressible tip 14 moved towards the proximal end 16 of the elongate body 12. The overlapping spirals of the material of the compressible tip 14 enable this movement. Each smaller circle of the spiral can slide proximally within the next larger circle of material, thereby retracting, or compressing, the compressible tip 14. The material of the compressible tip 14 is preferably formed of a material having a shape memory, such that it springs back to its former shape when it no longer abuts a surface 20. Many of the materials listed above perform this task adequately.

In use, therefore, if the toothpick 10 is pushed too hard against the user's gum tissue, the compressible tip 14 compresses and prevents damage to the gum tissue. Once the toothpick 10 is correctly oriented between a user's teeth, the user may move the toothpick 10 along a lateral axis in order to dislodge foreign matter, and the compressible tip 14 will not greatly compress, if at all. Thus, the toothpick 10 preferably prevents damage to a user's gums by compressing along one axis, while maintaining rigidity along a second axis.

Although the present invention has been described in terms of certain preferred embodiments, other embodiments of the invention including variations in dimensions, configuration and materials will be apparent to those of skill in the art in view of the disclosure herein. In addition, all features discussed in connection with any one embodiment herein can be readily adapted for use in other embodiments herein. The use of different terms or reference numerals for similar features in different embodiments does not imply differences other than those which may be expressly set forth. Accordingly, the present invention is intended to be described solely by reference to the appended claims, and not limited to the preferred embodiments disclosed herein.

What is claimed is:

1. A toothpick comprising:
a longitudinally compressible tip comprising a spirally wound ribbon.

2. The toothpick of claim 1, further comprising:
an elongate body configured adjacent a proximal end of the tip.

3. The toothpick of claim 1, wherein the spirally wound ribbon further comprises nylon.

4. A toothpick comprising:
an elongate body; and
a compressible tip configured at one end of the elongate body, said compressible tip comprising a tapered, overlapping spiral of nylon ribbon, wherein the distal end of said compressible tip is configured for insertion between a user's teeth.
